(19) United States
(12) Patent Application Publication
(10) Pub. No.: US 2026/0077521 A1
(43) Pub. Date: Mar. 19, 2026

(54) RAZOR HANDLE

(71) Applicant: DORCO CO., LTD., Seoul (KR)

(72) Inventors: Sung Hee SON, Seoul (KR); Jun Soo CHANG, Seoul (KR); Jong Jin JEONG, Seoul (KR)

(21) Appl. No.: 19/400,275

(22) Filed: Nov. 25, 2025

Related U.S. Application Data
(63) Continuation of application No. PCT/KR2024/007100, filed on May 24, 2024.

(30) Foreign Application Priority Data
May 26, 2023 (KR) 10-2023-0068696
Jul. 21, 2023 (KR) 10-2023-0095160

(51) Int. Cl. B26B 21/22; B26B 21/52

(52) U.S. Cl. CPC B26B 21/225; B26B 21/521

(57) ABSTRACT

A razor handle is proposed. The razor handle may be configured to be coupled to a razor cartridge that accommodates at least one blade. The razor handle may include a first restoring force-providing unit that provides a first restoring force against a first pivoting of the razor cartridge about a first rotation axis parallel to the extension direction of the blade. The razor handle may also include a second restoring force-providing unit that provides a second restoring force against the movement of the razor cartridge in a first direction from the razor cartridge toward the razor handle.

### CROSS REFERENCE TO RELATED APPLICATIONS

This is a continuation application of International Patent Application No. PCT/KR2024/007100 filed on May 24, 2024, which claims priority to Korean patent application No. 10-2023-0068696 filed on May 26, 2023 and Korean patent application No. 10-2023-0095160 filed on Jul. 21, 2023, contents of each of which are incorporated herein by reference in their entireties.

### BACKGROUND

### Technical Field

The present disclosure relates to a razor handle, and more specifically, to a razor handle for razors equipped with replaceable razor cartridges.

### Description of Related Technology

Razors are generally products designed for cutting facial hair or body hair, and are comprised of a handle for gripping and at least one blade-equipped razor cartridge that contacts the skin to perform shaving.

Such razors include systems where the razor cartridge is replaceable and disposable razors where the cartridge cannot be replaced.

### SUMMARY

One aspect is a razor handle that enables users to achieve a close and smooth shave.

The aspects of the disclosure are not limited to those described herein, and other aspects not mentioned herein may become apparent to those skilled in the art from the following description.

According to the embodiments of the disclosure, at least the following effects can be achieved:
Users can shave smoothly and closely to the skin.
Minimization of component damage even under external impacts.
Fewer parts required compared to other razor handles that perform the same function.
The razor cartridge can achieve high freedom of movement while ensuring user safety.

The effects of this disclosure are not limited to the examples cited above, and more varied effects are included within this specification.

### BRIEF DESCRIPTION OF THE DRAWINGS

FIG. 1 is a perspective view showing a razor assembly including a razor handle according to the first embodiment of the present disclosure.

FIG. 2 is a cross-sectional view taken along line I-I′ of FIG. 1.

FIG. 3 is a perspective view of the head portion according to the first embodiment of the present disclosure.

FIG. 4 is an exploded perspective view of the head portion according to the first embodiment of the present disclosure.

FIG. 5 is a perspective view of the first restoring force providing part according to the first embodiment of the present disclosure.

FIG. 6 is a perspective view of the plunger housing according to the first embodiment of the present disclosure.

FIG. 7 is an exploded perspective view of the plunger housing according to the first embodiment of the present disclosure.

FIG. 8 is a perspective view of the operation part according to the first embodiment of the present disclosure.

FIG. 9 is an exploded perspective view of the second restoring force providing part according to the first embodiment of the present disclosure.

FIG. 10 is a perspective view of the head housing according to the first embodiment of the present disclosure.

FIG. 11 is a cross-sectional view taken along line IV-IV′ of FIG. 10.

FIG. 12 is a cross-sectional view taken along line II-II′ of FIG. 3.

FIG. 13 is a cross-sectional view taken along line III-III′ of FIG. 3.

FIG. 14 is a conceptual diagram of FIG. 13.

FIG. 15 is a conceptual diagram showing a cross-sectional view taken along line III-III′ of FIG. 3 of the head portion according to the second embodiment of the present disclosure.

FIG. 16 is a conceptual diagram showing a cross-sectional view taken along line III-III′ of FIG. 3 of the head portion according to the third embodiment of the present disclosure.

### DETAILED DESCRIPTION

Recently, to provide users with an improved shaving experience, system razors equipped with a pivoting function for the razor cartridge have been introduced.

In these cases, the pivoting function of the razor not only allows rotation around an axis parallel to the direction of the blade extension but can also provide rotation around an axis perpendicular to the direction of the blade extension.

This pivoting capability enhances the freedom of movement of the razor cartridge during shaving, allowing for a closer shave that adheres more effectively to the user's skin. Consequently, this can effectively prevent cuts or injuries to the skin during shaving.

The advantages and features of the present disclosure, and methods of achieving them, will become apparent with reference to the embodiments described below in detail in conjunction with the accompanying drawings. However, the present disclosure is not limited to the embodiments disclosed herein and may be embodied in various other forms. These embodiments are provided to make the disclosure of the present disclosure thorough and to fully convey the scope of the disclosure to those skilled in the art, and the present disclosure is defined only by the claims.

Furthermore, the embodiments described in this specification will be explained with reference to cross-sectional views and/or schematic diagrams, which are ideal exemplary illustrations of the disclosure. Thus, the shapes of the exemplary illustrations may be modified based on manufacturing techniques and/or tolerances. Additionally, each component shown in the figures may be exaggerated or reduced for convenience of explanation. Throughout the specification, like reference numerals refer to like elements.

Also, in describing the elements of the embodiments of the present disclosure, terms such as first, second, i), ii), a), b), etc., may be used. These terms are only used to distinguish one element from another and do not inherently specify the nature, order, or sequence of the elements. When a component is said to “include” or “comprise” another component, it means that other components are not excluded and can be included unless specifically stated otherwise.

Additionally, in this specification, the longitudinal direction refers to the x-axis direction in the drawings, the first direction refers to the y-axis direction, the forward direction refers to the positive y-axis direction, the rearward direction refers to the negative y-axis direction, the upward direction refers to the positive z-axis direction, the downward direction refers to the negative z-axis direction, and the height direction refers to the z-axis direction.

Hereinafter, the present disclosure will be described with reference to the drawings illustrating the razor handle according to the embodiments of the present disclosure.

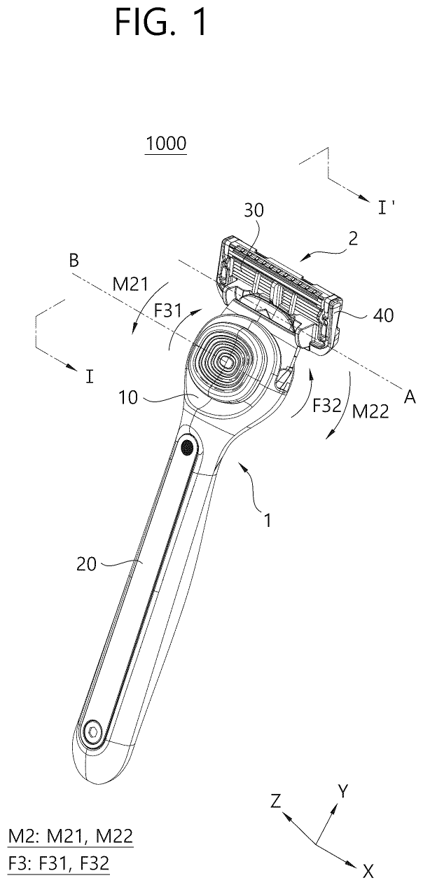

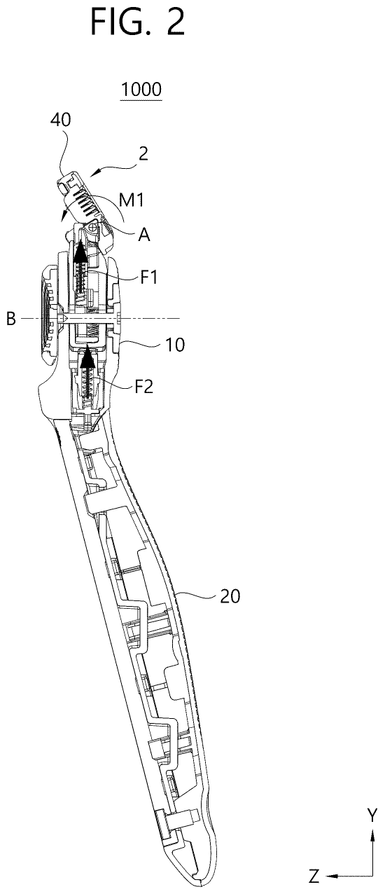

FIG. 1 is a perspective view showing a razor assembly including a razor handle according to the first embodiment of the present disclosure, and FIG. 2 is a cross-sectional view taken along line I-I′ of FIG. 1.

Referring to FIGS. 1 and 2, the razor assembly 1000 according to one embodiment includes a razor handle 1 that a user grips and a razor cartridge 2 that is detachably coupled to the razor handle 1.

According to the embodiment, the razor cartridge 2 can be detachably coupled to the razor handle 1.

The razor cartridge 2 may include at least one blade 30 extending in the longitudinal direction.

One side of the blade housing 40 may be formed with a connector (not shown) that is detachably coupled to the razor handle 1.

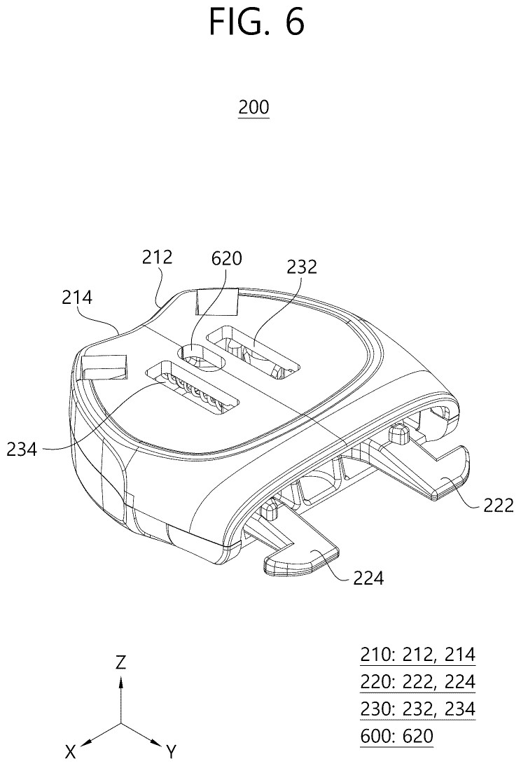

Parts of the first arm 222 (see FIG. 6) and the second arm 224 (see FIG. 6) of the razor handle 1 may be positioned inside the connector (not shown) to couple the razor handle 1 and the razor cartridge 2.

The razor handle (1) may include a head portion (10) and a grip portion (20).

The head portion (10) is the part of the razor handle (1) that is directly and detachably coupled to the razor cartridge (2) and directly rotates the razor cartridge (2). The grip portion (20) is the part that is directly grasped by the user and extends rearward from the head portion (10).

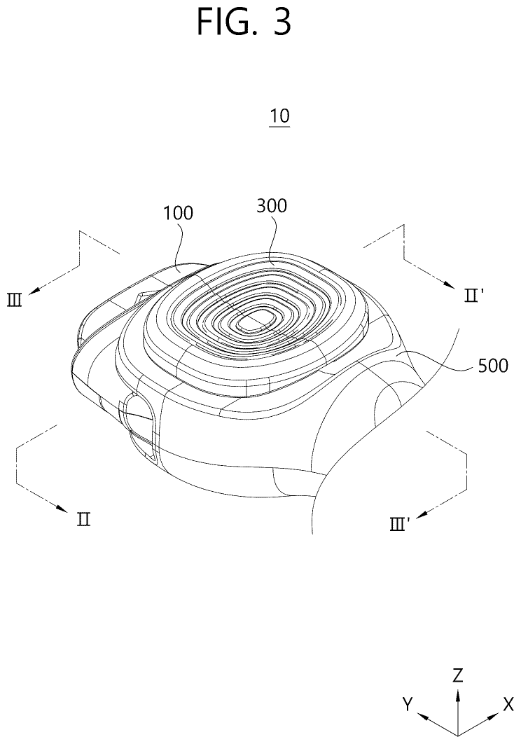

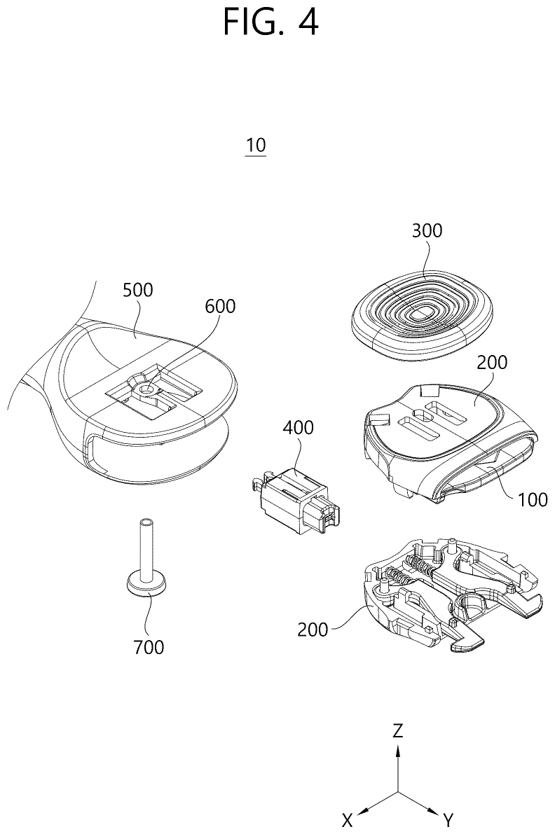

FIG. 3 is a perspective view of the head portion according to the first embodiment of the present disclosure, and FIG. 4 is an exploded perspective view of the head portion according to the first embodiment of the present disclosure.

Referring to FIGS. 3 and 4, the head portion (10) may include a first restoring force providing part (100), a plunger housing (200), an operating part (300), a second restoring force providing part (400), and a head housing (500).

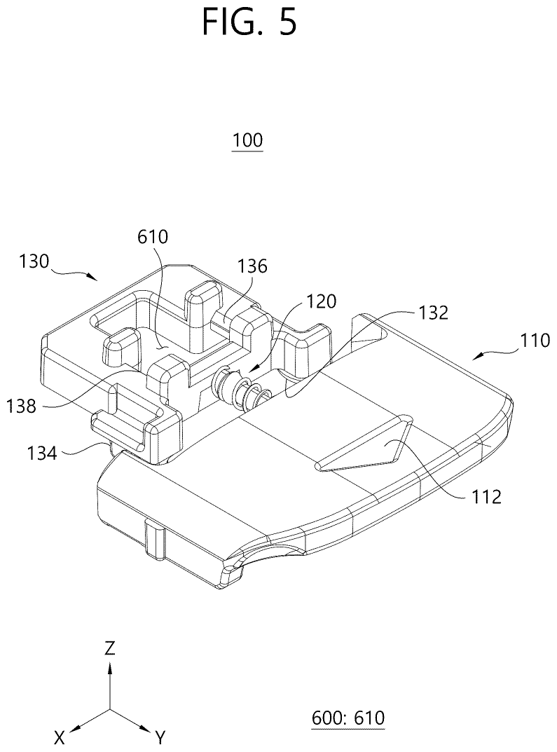

FIG. 5 is a perspective view of the first restoring force providing part according to the first embodiment of the present disclosure.

Referring to FIGS. 1, 2, and 5, the first restoring force providing part (100) is configured to provide a first restoring force (F1) by pressing the razor cartridge (2) to restore it to the neutral position when the razor cartridge (2) performs a first rotation (M1) about the first rotation axis (A). Here, the neutral position refers to the position formed when no external force is applied to the razor cartridge (2) in the state where the razor cartridge (2) is coupled to the razor handle (1).

The first restoring force providing part (100) may include a first pressing part (110), a first elastic member (120), and a second pressing part (130).

The first pressing part (110) may be in direct contact with the razor cartridge (2) to provide a forward first restoring force (F1) to the razor cartridge (2).

Additionally, the first pressing part (110) may include a display part (112) on its upper surface to allow the user to easily couple the razor handle (1) and the razor cartridge (2).

The first elastic member (120) is positioned at the rear of the first pressing part (110) and provides an elastic force to the first pressing part (110) so that the first pressing part (110) can provide the first restoring force (F1) to the razor cartridge (2).

The first elastic member (120) may include a spring or other configuration capable of providing an elastic force to the first pressing part (110).

The second pressing part (130) is positioned at the rear of the first elastic member (120) and may include a first operating part (132), a second operating part (134), a first coupling part (136), and a second coupling part (138).

The first operating part (132) and the second operating part (134) are configured to operate the first arm (222, see FIG. 6) and the second arm (224, see FIG. 6) described later, and the first coupling part (136) and the second coupling part (138) are configured to couple with the operating part (300) described later.

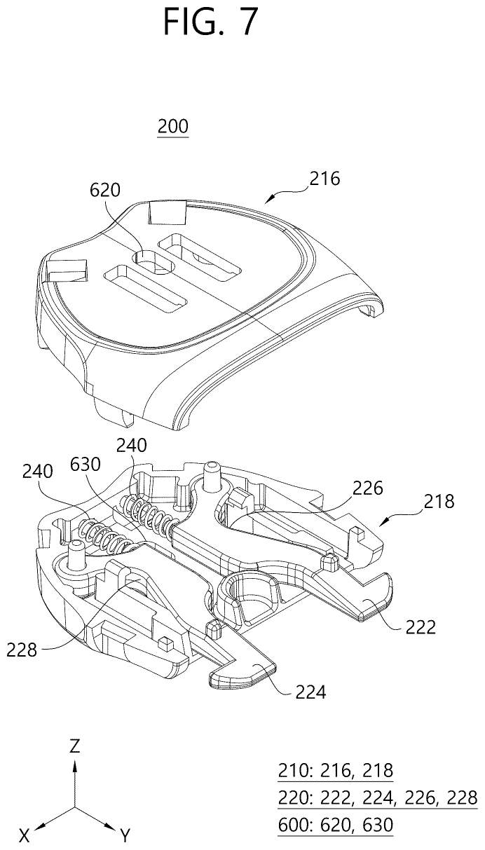

FIG. 6 is a perspective view of the plunger housing according to the first embodiment of the present disclosure, and FIG. 7 is an exploded perspective view of the plunger housing according to the first embodiment of the present disclosure.

Referring to FIGS. 1, 2, 6, and 7, the plunger housing (200) is assembled to surround the first restoring force providing part (100) from above and below, accommodating at least part of the first restoring force providing part (100).

The plunger housing (200) may include a shell (210), coupling arms (220), holes (230), and a second elastic member (240).

Referring to FIGS. 6 and 7, the shell (210) may include a first surface (212) and a second surface (214) at the rear, and may include an upper shell (216) and a lower shell (218).

The first surface (212) and the second surface (214) may be formed so that the distance between them increases toward the rear. Additionally, the first surface (212) and the second surface (214) may be formed concavely toward the rear.

The upper shell (216) is positioned above the first restoring force providing part (100) in the head portion (10), and the lower shell (218) is positioned below the first restoring force providing part (100) in the head portion (10).

The upper shell (216) and the lower shell (218) are assembled from above and below to accommodate the first restoring force providing part (100). Referring to FIG. 3, the upper shell (216) and the lower shell (218) may not accommodate the entire first restoring force providing part (100).

The coupling arms (220) are configured to directly couple with the razor cartridge (2) in the head portion (10) and may include a first arm (222), a second arm (224), a first recess (226), and a second recess (228).

Referring to FIG. 7, the first arm (222) and the second arm (224) may extend laterally so that their longitudinal distance from each other decreases towards the rear and then increases. The first arm (222) and the second arm (224) may be symmetrically formed with respect to an imaginary plane parallel to the yz plane.

That is, the first arm (222) and the second arm (224) may each have a first recess (226) and a second recess (228) formed on their outer sides, respectively.

Additionally, the second elastic member (240) may be positioned at the rear of each of the first arm (222) and the second arm (224). The second elastic member (240) can apply an elastic force in the first direction to each of the first arm (222) and the second arm (224) to restore them to the neutral position. In the embodiment of the present disclosure, the second elastic member (240) includes a spring but is not limited thereto.

Referring to FIGS. 4, 5, and 7, when assembling the first restoring force providing part (100) and the plunger housing (200), the first operating part (132) and the second operating part (134) can be positioned in the first recess (226) and the second recess (228), respectively. When the first operating part (132) and the second operating part (134) are positioned in the first recess (226) and the second recess (228), the first arm (222) and the second arm (224) are in the neutral position.

When the razor handle (1) and the razor cartridge (2) are coupled, the first arm (222) and the second arm (224) are inserted into the connector (not shown). In this case, the position of the first arm (222) and the second arm (224) is referred to as the neutral position.

When the user moves the second pressing part (130) forward in the state where the razor handle (1) and the razor cartridge (2) are coupled, the first operating part (132) and the second operating part (134) move forward from the first recess (226) and the second recess (228), respectively. The method by which the user moves the second pressing part (130) forward will be described later.

Due to the movement of the first operating part (132) and the second operating part (134), if the second pressing part (130) presses the first arm (222) and the second arm (224) inward, the distance between the front ends of the first arm (222) and the second arm (224) decreases, and at least one of the front ends of the first arm (222) and the second arm (224) is positioned to disengage from the connector (not shown), thereby allowing the head portion (10) to be separated from the razor cartridge (2).

Meanwhile, the upper shell (216) may have a first hole (232) and a second hole (234) formed therein. The first hole (232) and the second hole (234) may each be formed to penetrate in the height direction and extend in the first direction, and may have the same shape. The functions of the first hole (232) and the second hole (234) will be described later.

Referring to FIGS. 1, 2, and 7, examining the first rotation (M1) of the razor cartridge (2) relative to the razor handle (1), the first rotation axis (A, see FIG. 1), which is the axis of the first rotation (M1), can be defined by the front ends of the first arm (222) and the second arm (224), and the first rotation axis can be positioned adjacent to the front ends of the first arm (222) and the second arm (224). That is, the first rotation axis (A) can be parallel to the longitudinal direction.

The razor cartridge (2) performs the first rotation (M1) about the first rotation axis (A) when an external force is applied in the neutral position. For the first rotation (M1) of the razor cartridge (2), the first restoring force providing part (100) can apply the first restoring force (F1) forward to restore the razor cartridge (2) back to the neutral position.

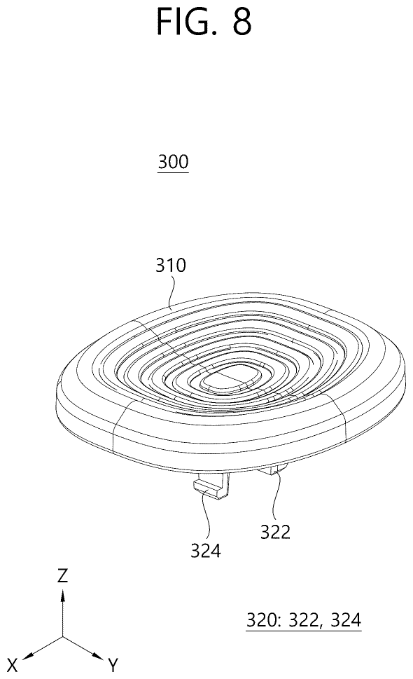

FIG. 8 is a perspective view of the operation part according to the first embodiment of the present disclosure.

Referring to FIGS. 4 and 8, the operation part (300) is located above the plunger housing (200) in the head portion (10) and is configured to control the attachment and detachment of the razor cartridge (2) from the razor handle (1). It can include an operation upper surface (310) and a protrusion (320).

The operation upper surface (310) is the part where the user places their finger when detaching the razor cartridge (2) from the razor handle (1). To increase the contact area for stable finger contact by the user, the operation upper surface (310) may be concavely formed from the upper side.

The protrusion (320) is configured to couple the operation part (300) with the plunger housing (200) and the head housing (500), and may include a first protrusion (322) and a second protrusion (324).

The first protrusion (322) and the second protrusion (324) extend downward from the bottom surface of the operation part (300) and may have different shapes from each other to facilitate single-direction assembly of the operation part (300) during the manufacturing process of the razor assembly (1000).

Referring to FIGS. 4, 5, 6, and 8, the first protrusion (322) and the second protrusion (324) of the operation part (300) can be inserted into the first hole (232) and the second hole (234) of the plunger housing (200), respectively.

Additionally, the lower ends of the first protrusion (322) and the second protrusion (324) of the operation part (300) can be coupled with the first coupling part (136) and the second coupling part (138) of the first restoring force providing part (100). In the embodiment of the present disclosure, the operation part (300) and the first restoring force providing part (100) are hook-coupled, but are not limited thereto.

Therefore, when the user moves the operation part (300) forward, the operation part (300) moves the second pressing part (130) of the first restoring force providing part (100) forward. The forward-moving second pressing part (130) moves the first operating part (132) and the second operating part (134) forward, thereby operating the first arm (222) and the second arm (224) so that the user can detach the razor cartridge (2) from the razor handle (1).

Meanwhile, when the razor cartridge (2) moves backward due to external force, the first restoring force providing part (100), the plunger housing (200), and the operation part (300) can move backward together.

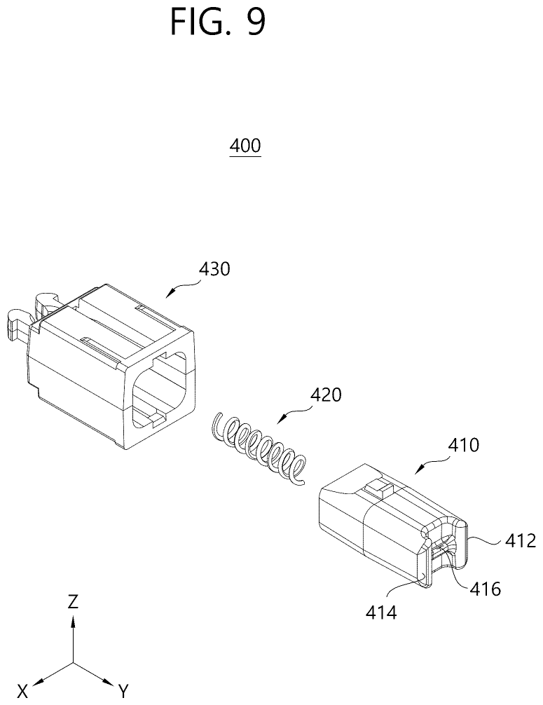

FIG. 9 is an exploded perspective view of the second restoring force providing part according to the first embodiment of the present disclosure.

Referring to FIGS. 4 and 9, the second restoring force providing part (400) is positioned at the rear of the plunger housing (200) in the head portion (10) and is configured to provide the second restoring force (F2, see FIG. 2) and the third restoring force (F3, see FIG. 1) to the plunger housing (200). It may include a third pressing part (410), a third elastic member (420), and an elastic member housing (430).

The razor handle (1) according to the present disclosure can perform movement in the first direction and the second rotation (M2) of the plunger housing (200) with a minimal number of components.

The third pressing part (410) is configured to provide the second restoring force (F2) and the third restoring force (F3) by contacting the plunger housing (200). It can include one side (412), the other side (414), and an interstitial space (416).

The third elastic member (420) is located at the rear of the third pressing part (410) and can apply elastic force forward to the third pressing part (410). According to an embodiment of the present disclosure, the third elastic member (420) includes a spring, but is not limited thereto.

The elastic member housing (430) can be fixed at a position within the head housing (500) to secure one end of the third elastic member (420).

Referring to FIGS. 1, 2, 4, and 9, in the neutral position, one side (412) and the other side (414) of the third pressing part (410) are stably in contact with the first surface (212) and the second surface (214) of the shell (210) of the plunger housing (200). When the razor cartridge (2) moves backward due to the external force generated during shaving, the contact between one side (412) and the other side (414) of the third pressing part (410) and the first surface (212) and the second surface (214) of the shell (210) is maintained. As a result, the razor cartridge (2), the first restoring force providing part (100), and the plunger housing (200) can move backward simultaneously.

The third pressing part (410), which has moved backward, is returned to its original position by the second restoring force (F2) applied forward by the third elastic member (420). As the third pressing part (410) returns to its original position, it presses the plunger housing (200) forward, causing the razor cartridge (2) to also return to its original position.

In other words, the movement of the razor cartridge (2) in the first direction can be controlled by the second restoring force (F2) provided by the second restoring force providing part (400).

This cushioning function of the second restoring force providing part (400) can provide a smoother shaving experience for the user. Additionally, even in the event of an external impact such as a drop, the cushioning function of the second restoring force providing part (400) can disperse the impact, minimizing damage to the components of the razor assembly (1000).

Moreover, the second restoring force providing part (400) can provide the third restoring force (F3) for the second rotation (M2) of the razor cartridge (2) around the second rotation axis (B, see FIG. 2). The specific method and direction of the third restoring force (F3) will be described later.

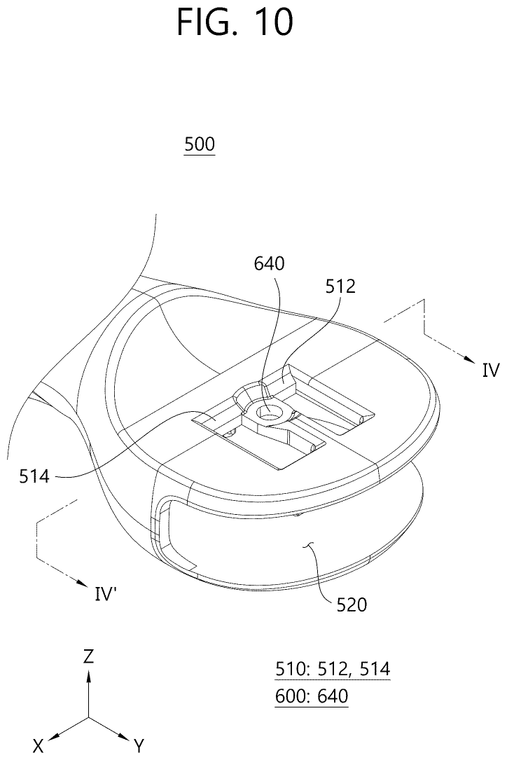

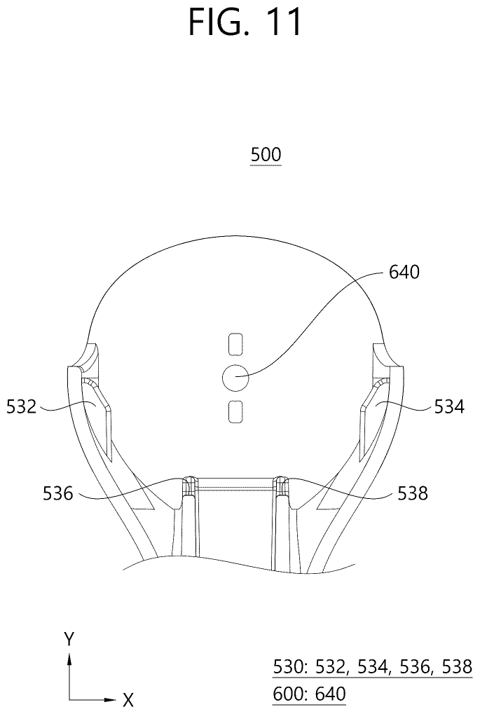

FIG. 10 is a perspective view of the head housing according to the first embodiment of the present disclosure, and FIG. 11 is a cross-sectional view taken along line IV-IV′ of FIG. 10.

Referring to FIGS. 10 and 11, the head housing (500) may include through-holes (510), an internal space (520), and a stopper (530).

Referring to FIGS. 3 and 4, the operation part (300) may be positioned on the upper side of the head housing (500). More specifically, the through-holes (510) may include a first through-hole (512) and a second through-hole (514), and the first through-hole (512) and the second through-hole (514) may each receive the first protrusion (322) and the second protrusion (324) of the operation part (300) from the upper side.

Thus, the protrusion (320) of the operation part (300) is inserted into the through-holes (510) and holes (230) to engage with the second pressing part (130) of the first restoring force providing part (100).

In order for the protrusion (320) of the operation part (300) to be inserted into the through-holes (510) of the head housing (500) and for the user to operate the operation part (300) forward, each of the first through-hole (512) and the second through-hole (514) may be formed to penetrate in the height direction and extend in the length direction.

Furthermore, to facilitate unidirectional assembly of the operation part (300) during the manufacturing process of the razor assembly (1000), the shapes of the first through-hole (512) and the second through-hole (514) may differ corresponding to the shapes of the first protrusion (322) and the second protrusion (324).

Referring to FIGS. 3, 4, and 10, the head housing (500) includes an internal space (520). The internal space (520) can sequentially accommodate at least a portion or all of the second restoring force providing part (400), the plunger housing (200), and the first restoring force providing part (100).

Referring to FIG. 11, the stopper (530) is located within the internal space (520) of the head housing (500) and can limit the maximum rearward movement distance of the plunger housing (200). In the embodiment of the present disclosure, the stopper (530) includes a first stopper (532), a second stopper (534), a third stopper (536), and a fourth stopper (538), but there is no restriction on the number and arrangement as long as they can limit the maximum rearward movement distance of the plunger housing (200).

Each of the first stopper (532), the second stopper (534), the third stopper (536), and the fourth stopper (538) is spaced at a predetermined interval and positioned on the inner wall of the head housing.

The first stopper (532) and the second stopper (534) may be formed symmetrically with respect to an imaginary plane parallel to the yz plane.

Similarly, the third stopper (536) and the fourth stopper (538) may be formed symmetrically with respect to an imaginary plane parallel to the yz plane.

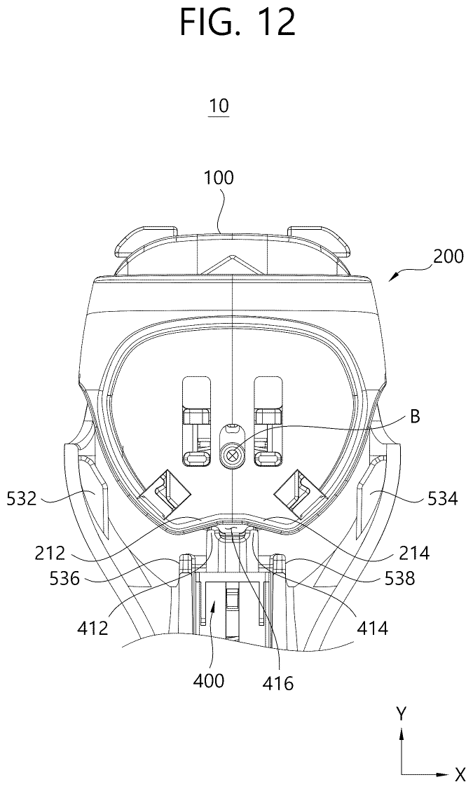

FIG. 12 is a cross-sectional view taken along line II-II′ of FIG. 3.

Referring to FIGS. 3, 4, and 12, the third stopper (536) and the fourth stopper (538) of the head housing (500) can be fixed so that the third elastic member (420) of the second restoring force providing part (400) provides elastic force forward. That is, one side of the second restoring force providing part (400) is fixed within the head housing (500).

In the internal space (520) of the head housing (500) within the head portion (10), the assembly of the first restoring force providing part (100) and the plunger housing (200) is positioned in front of the second restoring force providing part (400).

When the assembly of the first restoring force providing part (100) and the plunger housing (200), the second restoring force providing part (400), and the head housing (500) are assembled, the third elastic member (420) of the second restoring force providing part (400) is in a partially compressed state. That is, the third elastic member (420) is in a pre-loading state.

When the third elastic member (420) is in a pre-loading state, the second restoring force providing part (400) can perform a cushioning function more stably due to the elastic force of the elastic member. That is, the effects such as improved shaving comfort and minimization of component damage due to external shocks can be enhanced by the second restoring force providing part (400).

Referring to FIGS. 1 and 12, the second rotation (M2) around the second rotation axis (B) of the razor cartridge (2) by the second restoring force providing part (400) and the provision of the third restoring force (F3) to the razor cartridge (2) can be confirmed.

The second rotation (M2) includes a first rotational movement (M21) and a second rotational movement (M22).

In the neutral state, one side (412) of the third pressing part (410) can contact the first surface (212) of the shell (210), and the other side (414) of the third pressing part (410) can contact the second surface (214) of the shell (210), and the space (416) between the one side (412) and the other side (414) may not contact the first surface (212) and the second surface (214) of the shell (210).

That is, the space (416) does not contact the plunger housing (200), minimizing friction between the third pressing part (410) and the plunger housing (200), allowing the second rotation (M2) of the razor cartridge (2) to be smoother.

When the razor cartridge (2) is in the state of the first rotational movement (M21), one side (412) of the third pressing part (410) contacts the first surface (212) of the shell (210), and the other side (414) of the third pressing part (410) may not contact the second surface (214) of the shell (210). Therefore, although the third elastic member (420) applies a restoring force forward, only the one side (412) of the third pressing part (410) presses the plunger housing (200) through the first surface (212) of the shell (210), so the direction of the first restoring force (F31) of the third restoring force (F3) may be opposite to the direction of the first rotational movement (M21), that is, perpendicular to the first surface (212) of the shell (210).

Furthermore, when the razor cartridge (2) is in the state of the second rotational movement (M22), the other side (414) of the third pressing part (410) contacts the second surface (214) of the shell (210), and the one side (412) of the third pressing part (410) may not contact the first surface (212) of the shell (210). Therefore, although the third elastic member (420) applies a restoring force forward, only the other side (414) of the third pressing part (410) presses the plunger housing (200) through the second surface (214) of the shell (210), so the direction of the second restoring force (F32) of the third restoring force (F3) may be opposite to the direction of the second rotational movement (M22), that is, perpendicular to the second surface (214) of the shell (210).

In other words, the second restoring force providing part (400) can provide the second restoring force (F2) and the third restoring force (F3) to the plunger housing (200) through the forward and backward movement of the third pressing part (410).

However, due to the forward and backward movement of the razor cartridge (2) by the second restoring force providing part (400), the second rotation axis (B) can move forward and backward together with the plunger housing (200).

Additionally, the second rotation (M2) of the razor cartridge (2) can be limited when the backward movement of the razor cartridge (2) is at its maximum due to interference by the stopper (530) of the head housing (500) or the maximum backward movement of the second restoring force providing part (400). Conversely, the backward movement of the razor cartridge (2) can be limited when the second rotation (M2) of the razor cartridge (2) is at its maximum.

The greater the degree of freedom of movement of the razor cartridge (2) relative to the razor handle (1), the better the adhesion to the user's skin. However, excessive freedom when shaving highly contoured surfaces such as the jaw or cheeks can expose the user to risks such as cuts.

Therefore, the razor handle (1) according to the present disclosure can enhance shaving safety by limiting the second rotation (M2) of the razor cartridge (2) when the backward movement of the razor cartridge (2) is at its maximum, and by limiting the backward movement of the razor cartridge (2) when the second rotation (M2) of the razor cartridge (2) is at its maximum.

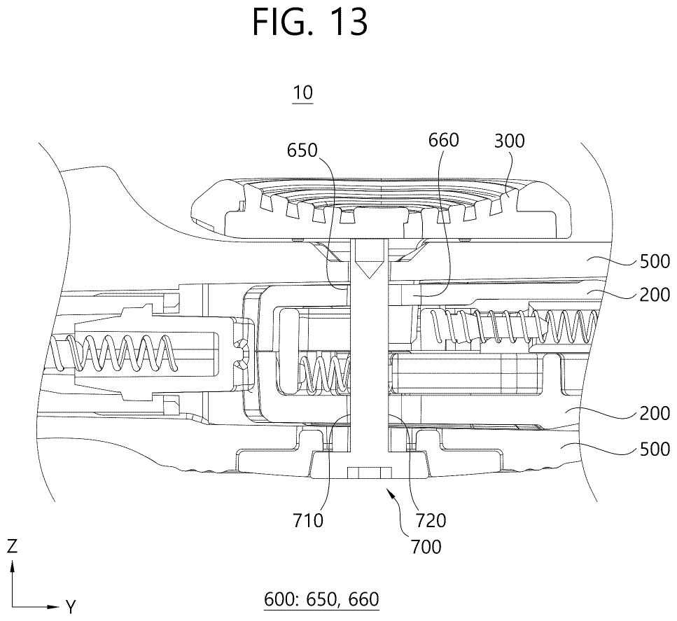

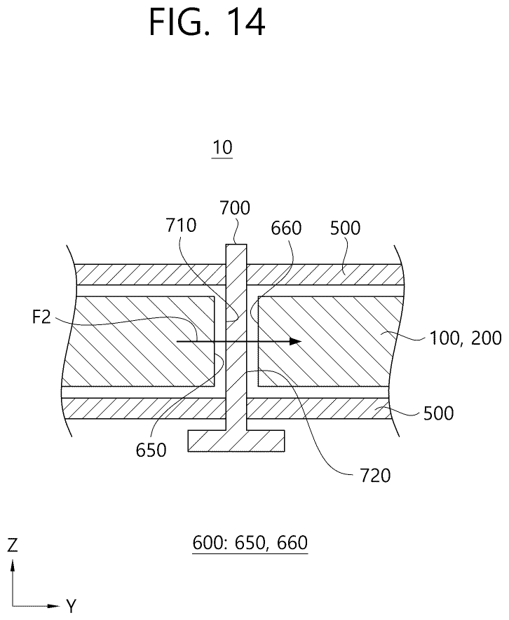

FIG. 13 is a cross-sectional view taken along the line III-III′ shown in FIG. 3, and FIG. 14 is a conceptual diagram of FIG. 13.

Referring to FIGS. 4, 13, and 14, the head portion (10) may include a third coupling part (600) and a fourth coupling part (700) that couple the plunger housing (200) and the head housing (500) in the height direction.

The third coupling part (600) not only couples the plunger housing (200) and the head housing (500) but also guides the forward and backward movement of the plunger housing (200) within the head housing (500).

Additionally, the fourth coupling part (700) not only couples the plunger housing (200) and the head housing (500) but also serves as the second rotation axis (B) for the second rotation (M2).

Referring to FIGS. 5, 7, 10, and 11, the third coupling part (600) according to the first embodiment of the present disclosure may be formed to penetrate in the height direction across the first restoring force providing part (100), the plunger housing (200), and the head housing (500). The height direction is a direction perpendicular to the first direction and the first rotation axis. That is, the third coupling part (600) may include a central coupling part (610) formed in the first restoring force providing part (100), an upper coupling part (620) and a lower coupling part (630) formed in the plunger housing (200), and an outer coupling part (640) formed in the head housing (500).

The fourth coupling part (700) according to the first embodiment of the present disclosure may be formed as a separate component such as a rivet and may couple the plunger housing (200) and the head housing (500) through engagement with the third coupling part (600).

Referring to FIG. 13, the fourth coupling part (700) is fitted into the third coupling part (600) from the lower side to the upper side of the head portion (10), more specifically, it is fitted into the outer coupling part (640) of the third coupling part (600).

The upper coupling part (620) and the lower coupling part (630) of the third coupling part (600) may be extended in a direction parallel to the first direction to allow the plunger housing (200) to move forward and backward within the head housing (500).

The first direction length of the upper coupling part (620) and the lower coupling part (630) may be longer by a value between 0.5 mm and 4 mm, preferably between 1.5 mm and 2.5 mm, than the width, i.e., the first direction length, of the fourth coupling part (700).

That is, the third coupling part (600) may be formed to have a maximum forward and backward movement distance of the plunger housing (200) between 0.5 mm and 4 mm, preferably between 1.5 mm and 2.5 mm.

Meanwhile, in the neutral state of the plunger housing (200) shown in FIGS. 13 and 14, one end (650) of the third coupling part (600) and one end (710) of the fourth coupling part (700) are in contact. One end (650) of the third coupling part may be one end of the upper coupling part (620) formed in the plunger housing (200).

When the plunger housing (200) is in the state of maximum backward movement relative to the head housing (500), the other end (660) of the third coupling part (600) and the other end (720) of the fourth coupling part (700) may not contact each other. The maximum backward movement of the plunger housing (200) relative to the head housing (500) may be limited by the stopper (530) of the head housing (500) rather than by the third coupling part (600) and the fourth coupling part (700). The other end (660) of the third coupling part may be the other end of the upper coupling part (620) formed in the plunger housing (200).

The distance between the plunger housing (200) and the stopper (530) in the first direction may be between 1.6 mm and 2.4 mm. Since this value is smaller than the maximum forward and backward movement distance provided by the third coupling part (600) and the fourth coupling part (700), the maximum backward movement distance of the plunger housing (200) relative to the head housing (500) may be limited by the stopper (530).

Therefore, when the backward movement of the plunger housing (200) relative to the head housing (500) is at its maximum, the other end of the third coupling part (600) and the other end of the fourth coupling part (700) do not contact each other, thereby preventing damage to the fourth coupling part (700) due to external impacts such as dropping.

In another embodiment, the movable distance of the third pressing part (410) in the first direction may be between 1.6 mm and 3.6 mm. Since this value is smaller than the maximum forward and backward movement distance provided by the third coupling part (600) and the fourth coupling part (700), the maximum backward movement distance of the plunger housing (200) relative to the head housing (500) may be limited by the movement of the third pressing part (410).

Therefore, when the backward movement of the plunger housing (200) relative to the head housing (500) is at its maximum, the other end of the third coupling part (600) and the other end of the fourth coupling part (700) do not contact each other, thereby preventing damage to the fourth coupling part (700) due to external impacts such as dropping.

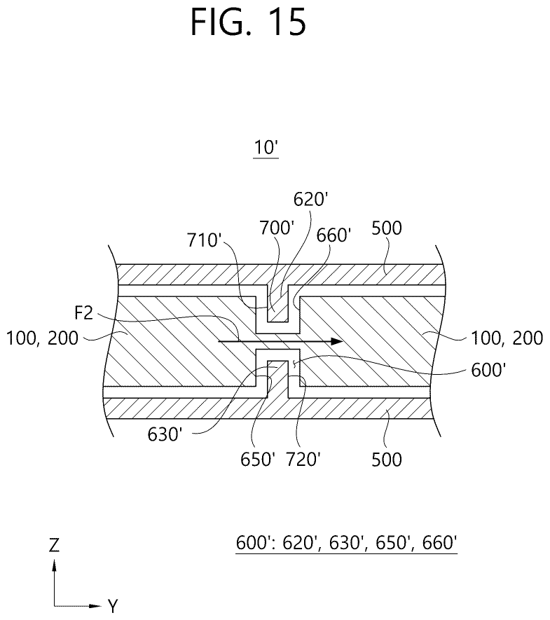

FIG. 15 is a conceptual diagram showing a cross-sectional view in the direction of III-III′ indicated in FIG. 3 of the head portion according to the second embodiment of the present disclosure.

The head portion (10′) according to the second embodiment has the third coupling part (600) and the fourth coupling part (700) slightly modified from the head portion (10) according to the first embodiment, and the same components will be omitted from the following description.

Referring to FIG. 15, the fourth coupling part (700′) according to the second embodiment of the present disclosure may be integrally formed with the head housing (500).

The third coupling part (600′) may be formed to be recessed in the height direction across the first restoring force providing part (100) and the plunger housing (200), and the fourth coupling part (700′) may be formed to extend inwardly from the head housing (500).

Meanwhile, the third coupling part (600′) may also be formed to penetrate in the height direction across the first restoring force providing part (100) and the plunger housing (200).

Furthermore, the third coupling part (600′) may be formed to extend in the first direction so that the plunger housing (200) can move back and forth inside the head housing (500).

The longitudinal length of the third coupling part (600′) may be longer than the longitudinal length of the fourth coupling part (700′) by a value between 0.5 mm and 4 mm, and preferably by a value between 1.5 mm and 2.5 mm.

In other words, the third coupling part (600′) may be formed so that the maximum movement distance of the plunger housing (200) back and forth is between 0.5 mm and 4 mm, and preferably between 1.5 mm and 2.5 mm.

Meanwhile, according to the second embodiment of the present disclosure, one end (650′) of the third coupling part (600′) and one end (710′) of the fourth coupling part (700′) may contact each other in the neutral state of the plunger housing (200).

In the state where the plunger housing (200) has moved backward to the maximum with respect to the head housing (500), the other end (660′) of the third coupling part (600′) and the other end (720′) of the fourth coupling part (700′) may not contact each other, and the maximum backward movement of the plunger housing (200) with respect to the head housing (500) may be limited by the stopper (530) of the head housing (500) or by the movement of the second restoring force providing part (400), that is, the movement distance of the third pressing part (410).

Since the other end (660′) of the third coupling part (600′) and the other end (720′) of the fourth coupling part (700′) do not contact each other in the state where the plunger housing (200) has moved backward to the maximum with respect to the head housing (500), it is possible to minimize the damage to parts in case of an external impact.

As such, the head portion (10′) according to the second embodiment of the present disclosure requires fewer parts than the head portion (10) according to the first embodiment, making it easier to assemble, and reducing the defect rate of the razor assembly (1000) due to spacing between parts.

In addition, the head portion (10′) according to the second embodiment of the present disclosure can reduce the defect rate of the razor assembly (1000) due to spacing between parts by filling the space between the third coupling parts (600′) with the plunger housing (200).

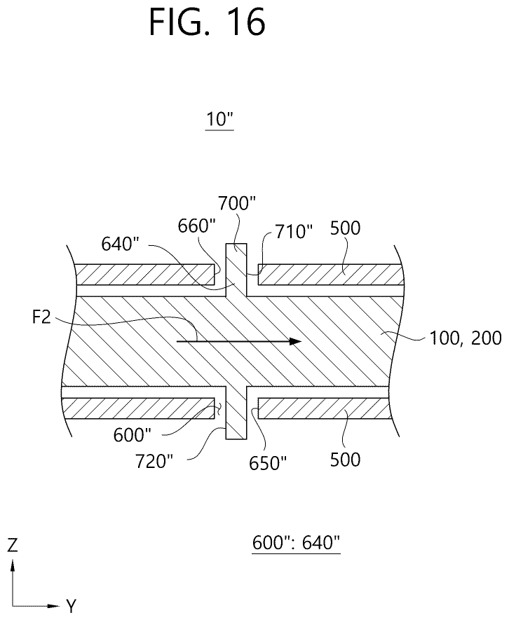

FIG. 16 is a conceptual diagram showing a cross-sectional view in the direction of III-III′ indicated in FIG. 3 of the head portion according to the third embodiment of the present disclosure.

The head portion (10″) according to the third embodiment has the third coupling part (600) and the fourth coupling part (700) slightly modified from the head portion (10) according to the first embodiment, and the same components will be omitted from the following description.

Referring to FIG. 16, the third coupling part (600″) may be formed to penetrate in the height direction of the head housing (500), and the fourth coupling part (700″) may be formed to extend outwardly from the plunger housing (200).

Meanwhile, although not shown in a separate drawing in this specification, the third coupling part (600″) may also be formed to be recessed similarly to the third coupling part (600′) according to the second embodiment.

Furthermore, the third coupling part (600″) may be formed to extend in the longitudinal direction so that the plunger housing (200) can move back and forth inside the head housing (500).

The longitudinal length of the third coupling part (600″) may be longer than the longitudinal length of the fourth coupling part (700″) by a value between 0.5 mm and 4 mm, and preferably by a value between 1.5 mm and 2.5 mm.

In other words, the third coupling part (600″) may be formed so that the maximum movement distance of the plunger housing (200) back and forth is between 0.5 mm and 4 mm, and preferably between 1.5 mm and 2.5 mm.

Meanwhile, according to the third embodiment of the present disclosure, one end (650″) of the third coupling part (600″) and one end (710″) of the fourth coupling part (700″) may contact each other in the neutral state of the plunger housing (200).

In the state where the plunger housing (200) has moved backward to the maximum with respect to the head housing (500), the other end (660″) of the third coupling part (600″) and the other end (720″) of the fourth coupling part (700″) may not contact each other, and the maximum backward movement of the plunger housing (200) with respect to the head housing (500) may be limited by the stopper (530) of the head housing (500) or by the movement distance of the third pressing part (410) of the second restoring force providing part (400).

Since the other end (660″) of the third coupling part (600″) and the other end (720″) of the fourth coupling part (700″) do not contact each other in the state where the plunger housing (200) has moved backward to the maximum with respect to the head housing (500), it is possible to minimize the damage to parts in case of an external impact.

As such, the head portion (10″) according to the third embodiment of the present disclosure requires fewer parts than the head portion (10) according to the first embodiment, making it easier to assemble, and reducing the defect rate of the razor assembly (1000) due to spacing between parts.

Referring to FIGS. 12 to 16, the maximum backward movement distance of the plunger housing (200) with respect to the head housing (500) may be determined by the shapes of the third coupling parts (600, 600′, 600″) and the fourth coupling parts (700, 700′, 700″), the movement restriction of the plunger housing (200) by the stopper (530) of the head housing (500), or the movement distance of the third pressing part (410) of the second restoring force providing part (400).

As described above, the maximum backward movement distance of the plunger housing (200) with respect to the head housing (500) may be formed to have a value between 0.5 mm and 4 mm, and preferably between 1.5 mm and 2.5 mm, based on the shapes of the third coupling parts (600, 600′, 600″) and the fourth coupling parts (700, 700′, 700″).

The maximum backward movement distance of the plunger housing (200) with respect to the head housing (500) by the stopper (530) of the head housing (500) may be limited to a value between 1.6 mm and 2.4 mm.

The maximum backward movement distance of the plunger housing (200) with respect to the head housing (500) by the movement distance of the third elastic member (420) may be limited to a value between 1.6 mm and 3.6 mm.

In other words, the maximum backward movement distance of the plunger housing (200) with respect to the head housing (500) may have a value between 0.5 mm and 4 mm, and preferably between 1.5 mm and 2.5 mm, in principle. However, to prevent damage to parts due to falls, etc., the maximum movement distance may be limited by the movement distance of the stopper (530) or the third elastic member (420). That is, the maximum movement distance of the plunger housing (200) may be shorter than the distance that can be provided by the shapes of the third coupling part (600) and the fourth coupling part (700).

As such, the razor handle (1) according to the present disclosure allows the user to shave smoothly and closely.

Furthermore, it can minimize damage to parts even when subjected to external impacts such as falls.

Additionally, it can have fewer parts compared to other razor handles (1) that perform the same function.

Those skilled in the art to which the present disclosure pertains will understand that the present disclosure can be embodied in other specific forms without changing its technical spirit or essential features. Therefore, the embodiments described above should be understood as illustrative in all respects and not restrictive. The scope of the present disclosure is indicated by the following claims rather than the foregoing detailed description, and all changes or modifications derived from the meaning, scope, and equivalent concept of the claims should be interpreted as being included in the scope of the present disclosure.

What is claimed is:

1. A razor handle configured to couple with a razor cartridge that accommodates at least one blade, the razor handle comprising:
a first restoring force providing part configured to provide a first restoring force for the first rotation of the razor cartridge about a first rotation axis parallel to the extending direction of the blade; and
a second restoring force providing part configured to provide a second restoring force for the movement of the razor cartridge in a first direction towards the razor handle from the razor cartridge, and a third restoring force for the second rotation of the razor cartridge about a second rotation axis perpendicular to the first rotation axis and the first direction.

2. The razor handle of claim 1, wherein:
the razor handle includes a plunger housing that accommodates at least part of the first restoring force providing part, and
the second restoring force providing part provides the second restoring force to the plunger housing.

3. The razor handle of claim 2, the razor handle comprises:
a head housing that accommodates at least part of the second restoring force providing part and the plunger housing;
a third coupling part formed to be recessed or penetrate in a direction perpendicular to the first direction and the first rotation axis in at least one of the head housing and the plunger housing; and
a fourth coupling part coupled within the third coupling part so that the plunger housing can be mounted to the head housing, and
wherein the third coupling part extends in the first direction.

4. The razor handle of claim 3, wherein the third coupling part is formed on each of the head housing and the plunger housing, and
wherein the fourth coupling part is a separate structure from each of the head housing and the plunger housing.

5. The razor handle of claim 3, wherein the third coupling part is formed on the plunger housing, and
wherein the fourth coupling part extends inwardly from the head housing.

6. The razor handle of claim 3, wherein the third coupling part is formed on the head housing, and
wherein the fourth coupling part extends outwardly from the plunger housing.

7. The razor handle of claim 3, wherein the plunger housing is configured to rotate about the second rotation axis relative to the head housing, in response to the razor cartridge performing the second rotates about the second rotation axis.

8. The razor handle of claim 3, wherein one end of the third coupling part and one end of the fourth coupling part are in contact in response to the razor cartridge being not moved in the first direction, and
wherein the other end of the third coupling part and the other end of the fourth coupling part are not in contact in response to the razor cartridge being moved to the maximum in the first direction.

9. The razor handle of claim 3, wherein the third coupling part is formed to have a maximum movement distance in the first direction of the plunger housing due to the second restoring force providing part between 0.5 mm and 4.0 mm.

10. The razor handle of claim 2, wherein the razor handle includes a head housing that accommodates the second restoring force providing part, and
wherein the head housing comprises a stopper that limits the maximum movement distance of the plunger housing in the first direction inside the head housing.

11. The razor handle of claim 10, wherein the maximum movement distance of the plunger housing in the first direction is between 1.6 mm and 2.4 mm.

12. The razor handle of claim 2, wherein the razor handle includes a head housing that accommodates the second restoring force providing part,
wherein the second restoring force providing part includes an elastic member that provides the second restoring force, and
wherein the elastic member is configured to be partially compressed in response to the razor cartridge being in a neutral position.

13. The razor handle of claim 12, wherein the maximum movement distance in the first direction of the plunger housing controlled by the second restoring force providing part is between 1.6 mm and 3.6 mm.

14. The razor handle of claim 1, wherein the second rotation axis is movable along the first direction.

15. The razor handle of claim 1, wherein the second rotation of the razor cartridge is configured to be restricted in response to the razor cartridge being moved to the maximum in the first direction.

16. The razor handle of claim 1, wherein the movement of the razor cartridge in the first direction is configured to be restricted in response to the second rotation of the razor cartridge being at its maximum.

17. The razor handle of claim 1, wherein the razor handle includes a plunger housing that accommodates the first restoring force providing part,
wherein the second restoring force providing part includes an elastic member that provides the second restoring force and the third restoring force and a pressing part coupled to one side of the elastic member and in contact with the plunger housing, and
wherein the pressing part configured to move in the first direction based on the second rotation of the razor cartridge.

18. The razor handle of claim 17, wherein the second rotation includes a first rotational movement and a second rotational movement in opposite directions,
wherein one side of the pressing part is in contact with the plunger housing when the razor cartridge is in the first rotational movement state,
wherein the other side of the pressing part is in contact with the plunger housing when the razor cartridge is in the second rotational movement state, and
wherein one side and the other side of the pressing part are in contact with the plunger housing when the second rotation of the razor cartridge is restricted.

19. The razor handle of claim 18, wherein the plunger housing includes a first surface in contact with one side and a second surface in contact with the other side,
wherein the pressing part configured to be provide a restoring force to the plunger housing by pressing the first surface in a direction perpendicular to the first surface to rotate the razor cartridge from the first rotational movement state to the second rotational movement state, and
wherein the pressing part configured to be provide a restoring force to the plunger housing by pressing the second surface in a direction perpendicular to the second surface to rotate the razor cartridge from the second rotational movement state to the first rotational movement state.

20. The razor handle of claim 18, wherein the pressing part is formed so that the space between one side and the other side does not contact the plunger housing.
